(19) United States
(12) Patent Application Publication
(10) Pub. No.: US 2025/0334967 A1
(43) Pub. Date: Oct. 30, 2025

(54) Contactless Pushing of a Robot Capable of Autonomous Motion

(71) Applicant: Piaggio Fast Forward Inc., Boston, MA (US)

(72) Inventors: Gregory Stewart Lynn, Venice, CA (US); Tyson Phillips, Somerville, MA (US); Megan Pinette, Boston, MA (US); Jeffrey T. Schnapp, Cambridge, MA (US)

(21) Appl. No.: 19/189,018

(22) Filed: Apr. 24, 2025

Related U.S. Application Data
(60) Provisional application No. 63/639,105, filed on Apr. 26, 2024.

(51) Int. Cl. G05D 1/241

(52) U.S. Cl. CPC G05D 1/241

(57) ABSTRACT

A robot capable of autonomous motion responsive to contactless pushing by a leader is a self-powered vehicle that includes a motorized drive, a controller coupled to the motorized drive, and a set of sensors coupled to the controller. The controller is configured to sense, based on a set of signals from the set of sensors, movement of the leader in a leader trajectory and to operate the motorized drive so as to move the vehicle, based on the leader trajectory, in a manner wherein the vehicle is positioned substantially in front of the leader. A related method is also provided.

### CROSS-REFERENCE TO RELATED APPLICATIONS

This application claims the benefit of U.S. Provisional Application No. 63/639,105, filed Apr. 26, 2024, entitled “Contactless Pushing and Contactless Steering,” which is assigned to the assignee hereof and is hereby incorporated herein by reference in its entirety.

### TECHNICAL FIELD

The invention relates to contactless pushing of a robot capable of autonomous motion, and includes contactless steering of such a robot. Contactless pushing is a robotic behavior occurring when a robot travels in front of a leader, without any physical contact with the leader, under a condition wherein the trajectory of the robot is guided by the trajectory of the leader. Contactless steering is an example of contactless pushing and is a robotic behavior occurring when a robot changes direction in front of a leader, in response to angular motion of the leader relative to the robot. The leader directing the robotic behavior during contactless pushing is said to “lead from behind.”

### BACKGROUND ART

Current “adaptive” robot technology typically focuses on robots configured to trail a human leader and to follow along leader's path of travel. Robots that are capable of following a leader are becoming commonplace in the art. In US Patent App. Pub. No. 2021/0208589 to Qi, a self-driving luggage is discussed. The self-driving luggage has a central processing unit that is capable of entering a following mode. In US. Patent App. Pub. No. 2021/0031769 to Matsumoto, a following target identification system is discussed. The target identification system may help the robot keep a view on the following target.

### SUMMARY OF EMBODIMENTS

A robot being controlled by contactless pushing of a user may adjust its relationship with the user, e.g., to maintain standards of comfort, convenience, and social etiquette. In so doing, the robot may make adjustments in its distance from the leader, its linear and angular acceleration, and its progression through turns. The resulting choreography between the user and the robot is configured to be intuitive for the user, and to appear natural to passers-by.

In the embodiments herein the controller is described as “configured” to perform a set of functions. It will be apparent to the reader that functions described as performed by the controller in connection with the claimed robots may also be performed by the controller in connection with the claimed methods of operating a robot. Similarly, functions described as performed by the controller in connection with the claimed methods of operating a robot may also be performed by the controller in connection with the claimed robots.

In accordance with one embodiment, the invention provides a robot capable of autonomous motion responsive to contactless pushing by a leader. In this embodiment, the robot is a self-powered vehicle that includes a motorized drive, a controller coupled to the motorized drive, and a set of sensors coupled to the controller, so as to support autonomous motion of the vehicle. In this embodiment, the controller is configured to sense, based on a set of signals from the set of sensors, movement of the leader in a leader trajectory; and to operate the motorized drive so as to move the vehicle, based on the leader trajectory, in a manner wherein the vehicle is positioned substantially in front of the leader.

Optionally, the controller is further configured to operate the motorized drive in a manner so as to achieve and maintain a separation distance of the vehicle in front of the leader. As a further option the controller is further configured to operate the motorized drive so as to maintain the separation distance as a function of a linear velocity of the leader in a direction toward the vehicle. Also as further option, the controller is further configured to operate the motorized drive to maintain the separation distance in a set of tiers as a function of the linear velocity of the leader in a direction toward the vehicle, wherein the separation distance is maintained at distance di when the linear velocity of the leader in a direction toward the vehicle exceeds a first threshold linear velocity vi above zero.

Optionally, the controller is further configured to operate the motorized drive to maintain the separation distance in a set of tiers as a function of the linear velocity of the leader in a direction toward the vehicle, wherein the separation distance is maintained at distance d₁ when the linear velocity of the leader in a direction toward the vehicle exceeds a first threshold linear velocity v₁ above zero and at a distance d₂, d₂<d₁, when the linear velocity of the leader in a direction toward the vehicle exceeds a second threshold velocity v₂, v₂>v₁. As a further option, v₁ is about 0.2 m/s, v₂ is about 0.6 m/s, d₁ is about 900 mm, and d₂ is about 700 mm. In further related embodiments, under a condition in which the linear velocity of the leader in a direction toward the vehicle has just exceeded the second threshold velocity v₂, the controller is further configured to operate the motorized drive to decrease the separation distance from d₁ to d₂ at a rate between about 10 and 100 mm/s. Optionally, the controller is further configured to operate the motorized drive to stop movement of the vehicle under a condition in which the linear velocity of the leader in a direction toward the vehicle has just fallen below v₁.

In other related embodiments, the controller is further configured to determine presence of a rotational condition in which (i) the leader trajectory includes a component that is transverse to a line segment between the leader and the vehicle, so that there is angular motion of the leader, relative to the vehicle, and (ii) the angular motion of the leader is at an angular speed exceeding a threshold; and under the rotational condition, the controller is further configured to operate the motorized drive to rotate the vehicle about a rotational axis so as to be aimed in a direction defined by the line segment. Optionally, the controller is further configured to operate the motorized drive to rotate the vehicle about the rotational axis with a rotational speed based on the angular speed of the leader. As a further option, under the rotational condition the controller is further configured to determine angular acceleration of the leader and to operate the motorized drive to rotate the robot about the rotational axis with an angular acceleration based on the determined angular acceleration of the leader. Moreover, the controller may be further configured to operate the motorized drive to rotate the robot about the rotational axis with an angular acceleration that is at least 1.5 times the determined angular acceleration of the leader.

In accordance with other embodiments of the invention, a method is provided of operating a self-powered robot in a manner responsive to contactless pushing by a leader, the robot being equipped with a motorized drive, a controller coupled to the motorized drive, and a set of sensors coupled to the controller, so as to support autonomous motion of the vehicle. The method includes sensing, based on a set of signals from the set of sensors, movement of the leader in a leader trajectory; and operating the motorized drive so as to move the vehicle, based on the leader trajectory, in a manner wherein the vehicle is positioned substantially in front of the leader. A further related embodiment includes determining by the controller, based on data from the set of sensors, the leader's linear velocity in a direction and causing, by the processor, operation of the drive system to move the robot in the direction in a manner to achieve and maintain a separation distance from the leader, the separation distance being determined as a function of the leader's linear velocity.

In some embodiments of the invention, the function of the leader's velocity operates to establish a first separation distance d₁ with the leader's velocity exceeding a first threshold velocity v₁ and being less than a second threshold velocity v₂, v₂>v₁ (i.e., with the leader's velocity being between the first and second threshold velocities v₁ and v₂). In a further embodiment, the function operates to establish a second separation distance, d₂, d₂ being less than d₁, when the leader has reached a linear velocity that exceeds v₂ in the direction towards the robot. In some embodiments, v₁ is between about 0.1 m/s and about 0.5 m/s, v₂ is between about 0.4 m/s and about 2 m/sec, d₁ is between about 300 mm and about 2 m, and d₂ is between about 200 mm and about 1.5 m. In some embodiments, v₁ is about 0.2 m/s, v₂ is about 0.6 m/s, d₁ is about 900, and d₂ is about 700 mm.

According to some embodiments, the function operates to adjust the separation distance with a robotic acceleration of no greater than about Aₘₐₓ m/s² and a deceleration of no less than about Dₘᵢₙ, wherein Aₘₐₓ can range from about 0.5 m/s² to about 1.5 m/s² and Dₘᵢₙ can range from about −1.0 m/s² to about −0.3 m/s². In some embodiments, Aₘₐₓ is about 0.75 m/s² and Dₘᵢₙ is about −0.62 m/s².

According to some embodiments, the function operates to establish the separation distance d₂ by decreasing the distance from the leader at a steady rate r₁, wherein r₁ is between about 10 mm/s and about 100 mm/s. According to some embodiments, r₁ is about 33 mm/s.

According to some embodiments, the method further includes causing, by the processor, the robot to stop moving if the leader's linear velocity falls below v₁.

According to some embodiments, when the linear velocity of the leader is between v₁ and v₂, with a negative acceleration, the function operates to establish a separation distance d₃. In some such embodiments, d₃ is equal to d₂. According to some such embodiments, v₁ is between about 0.1 m/s and about 0.5 m/s, v₂ is between about 0.4 m/s and about 2 m/sec, d₁ is between about 300 mm and about 2 m, and both of d₂ and d₃ are between about 200 mm and about 1.5 m. In some embodiments, v₁ is about 0.1 m/s, v₂ is about 0.6 m/s, d₁ about 900 mm and, and both of d₂ and d₃ are about 700 mm.

In some embodiments, the robot responds to contactless steering by a leader by determining by the processor, based on data from the set of sensors, the leader's orbital angular velocity ω_{L} and an orbital angular acceleration α_{L} with respect to the current position of the robot and causing, by the processor, operation of the drive system to rotate the robot about a central axis, with a rotational velocity ω_{R} and an angular acceleration α_{R} that are determined as a function of ω_{L} and α_{L}.

According to some embodiments, the function operates to initiate rotation of the robot with angular acceleration α_{R} greater than the α_{L} when the leader has reached a threshold leader orbital angular velocity ω_{T}, with respect to the current position of the robot. In some embodiments, the function operates to cause a ratio R=α_{R}/α_{L} to be constant when the leader orbital angular velocity ω_{L} is greater than the threshold leader orbital angular velocity ω_{T}, and to cause the rotational angular velocity of the robot ω_{R} to fall to zero when the leader orbital angular velocity ω_{L} is less than the threshold leader orbital angular velocity ω_{T}. In some embodiments ω_{T} is between about 5°/s to about 20°/s, and R is between about 1.25 to about 2.25. In some embodiments, ω_{T} is about 13°/s, and R is about 1.75.

According to some embodiments, a method is described of operating a robot, equipped with a set of optical sensors, a processor and a drive system, the processor being coupled to the sensors and the drive system, in a manner responsive to contactless pushing and contactless steering by a leader. For such embodiments, the method may include: determining by the processor, based on data from the set of sensors a linear velocity of the leader in a direction towards the robot and an orbital angular velocity of the leader with respect to a current position of the robot; and causing, by the processor, operation of the drive system (i) to move the robot in the direction in a manner to achieve and maintain a separation distance from the leader, the separation distance being determined as a function of the linear velocity of the leader towards the robot and (ii) to adjust the robot's angular orientation with an angular velocity and an angular acceleration being determined as a function of the orbital angular velocity and angular acceleration of the leader with respect to the current position of the robot.

According to some embodiments, the function operates to establish a first separation distance when the leader has reached a first threshold linear velocity in a direction towards the robot, and further operates to initiate rotation of the robot with the rotational angular acceleration of the robot greater than the orbital angular acceleration of the leader when the leader has reached a threshold orbital angular velocity with respect to the current position of the robot.

According to some embodiments, the function operates to establish a second separation distance when the leader has reached a second threshold linear velocity in the direction towards the robot, wherein the second threshold linear velocity is greater than the first threshold linear velocity.

According to some embodiments, the function operates to cause the robot to exhibit a rotational angular acceleration that is proportional to the leader's orbital angular acceleration when the leader has achieved an orbital angular velocity above the threshold orbital angular velocity.

According to some embodiments, the function operates to cause the robot's rotational angular velocity to fall to zero when the leader's orbital angular velocity is below the threshold angular velocity.

According to some embodiments, the function operates to cause the robot to stop moving when simultaneously the leader's linear velocity falls below the first threshold linear velocity and the leader's orbital angular velocity falls below the first threshold orbital angular velocity.

### BRIEF DESCRIPTION OF THE DRAWINGS

The foregoing features of embodiments will be more readily understood by reference to the following detailed description, taken with reference to the accompanying drawings.

FIG. 1A is a perspective view of a robot and a leader during contactless pushing, with the leader leading the robot from behind.

FIG. 1B is a perspective view of the robot and the leader, shown in FIG. 1, during contactless steering.

FIG. 2 is a block diagram of components of the robot shown in FIG. 1 and FIG. 2.

FIG. 3 is a flow chart of behavioral decisions of a robot subject to contactless pushing.

FIG. 4 is a top view of the robot and leader during contactless pushing on a straight-line path.

FIG. 5 is a top view of the robot and leader during contactless pushing of the robot through a turn (contactless steering), beginning and ending with straight travel.

FIG. 6 is a graph of leader and follower speed, and follower separation distance, during following starting.

FIG. 7 is a graph of leader and follower acceleration during following starting.

FIG. 8 is a graph of following distance during basic following.

FIG. 9 is a graph of leader and follower speed, and follower separation distance, during following stopping.

FIG. 10 is a graph of follower rotational acceleration during various turns.

FIG. 11 is a graph of leader rotational acceleration during various turns.

FIG. 12 is a graph of leader and follower rotational speed during a turn.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

“About” means within a range of ±20%.

A “front” of a robot is a leading edge of the robot based on a present direction of travel of the robot.

“Contactless steering” is action taken by a leader without touching a suitably configured robot to cause the robot to execute a turn.

A “leader” is an autonomous entity (such as a human or robot) that by its own movement along a leader trajectory has the effect of guiding the movement of a suitably configured robot along a robot trajectory.

“Contactless pushing” occurs when a suitably configured robot, positioned in front of a leader, moves forward on a robot trajectory defined by a trajectory of the leader behind the robot, in such a manner that the robot remains dynamically positioned in front of the leader. Contactless pushing can typically include four actions:
1. Starting: the leader accelerates from a stationary position in a direction towards the robot to a speed that triggers basic pushing
2. Basic Pushing: The leader moves forward and the robot moves forward in order to remain positioned substantially in front of the leader at a separation distance determined by the leader's speed.
3. Stopping: As the leader slows down, the robot likewise slows down and comes to a stop when the leader's speed decreases below a threshold value.
4. Turning: the leader controls the rotational motion (yaw) of the robot by means of angular motion of the leader relative to the robot.

A “robot” is a self-powered vehicle having a motorized drive, a controller coupled to the motorized drive, and a set of sensors coupled to the controller, so as to support autonomous motion of the vehicle.

A “following robot” or a “follower” is a robot the movements of which along a robot trajectory are guided by the movements of a leader along a leader trajectory. If the leader moves along the leader trajectory behind the “following robot” then the leader is said to “lead from behind.”

“Relative angle” is the angle measured between the direction the robot is facing (a vector from the robot's center to the robot's front) to the leader's position (a vector from the robot's center to the leader's center).

An object “orbits” a second object when the object moves around an axis of the second object.

An object “rotates” when the object moves around its own axis.

“Velocity” of an item is a vector measuring a rate of change of displacement of the item with respect to time, and “speed” of an item is a scaler having a magnitude of the item's velocity.

“Angular speed” of an item is a rate of angular change of the item per unit time relative to an axis. The item's angular speed may be measured in degrees per second.

“Rotational speed” of an object is the rate of rotational motion about an axis.

“Orbital speed” is the rate of orbital motion of an object about an axis.

“Angular acceleration” is the rate of change of angular speed (orbital or rotational). Angular acceleration can be measured in degrees per second per second.

“Rotational” and “Orbital” acceleration are, respectively, the rate of change of rotational and orbital speed.

“Rotational speed of robot” quantifies how quickly the robot rotates around itself. It is defined as the change in angle over time (°/s) of the robot's front about the robot's rotational axis.

“Turning overcorrection” occurs when a robot turns more and/or faster than the leader as a reaction to a recognized turn of the leader. The rotational speed and/or motion of the robot surpasses that of the leader.

A “forward linear velocity” is a speed at which an object moves and a direction of travel of the object.

A “separation distance” is a distance between a point on a robot and a point on a leader. The space between the center of mass of the robot and the center of mass of the leader is an example of a separation distance. The space between the closest point of the robot to the leader and the closest point of the leader to the robot is another example of a separation distance.

A robot following a leader (even when following from in front of the leader) is “aimed” in a given direction when it is oriented for motion in the given direction in the course of ordinary operation of the robot in following the leader.

When the leader is leading from behind the robot, the robot is positioned “substantially in front of the leader” if the robot is within plus or minus 90 degrees of a direction of the leader's current trajectory.

Techniques are discussed herein for contactless pushing of a robot. Contactless pushing may enable a robot to be led by a leader while the leader travels behind the robot. This “lead from behind” technology may provide an increased level of comfort, accessibility, security, and visibility for the leader (also called a user) and/or increased maneuverability while navigating complex environments. Contactless pushing as discussed herein includes actions of starting, basic pushing, stopping, and turning. Examples of contactless pushing and turning behavior are discussed herein. Specific values of distances, speeds, accelerations are provided, but these are examples, and other values may be implemented.

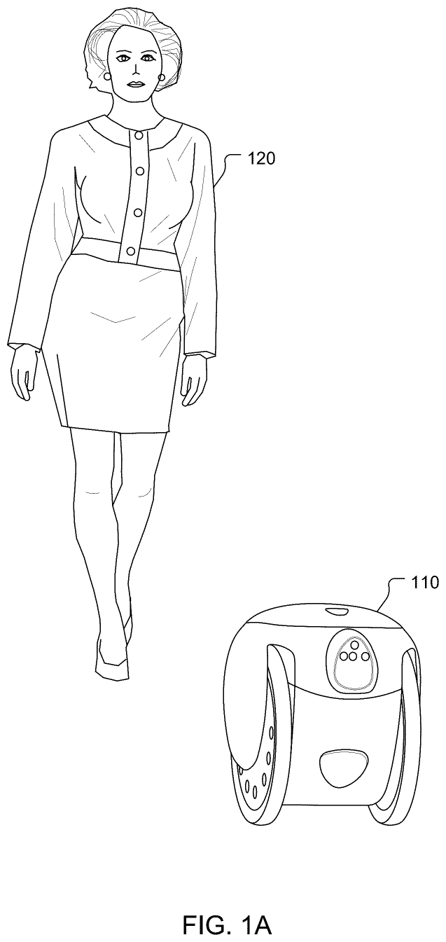

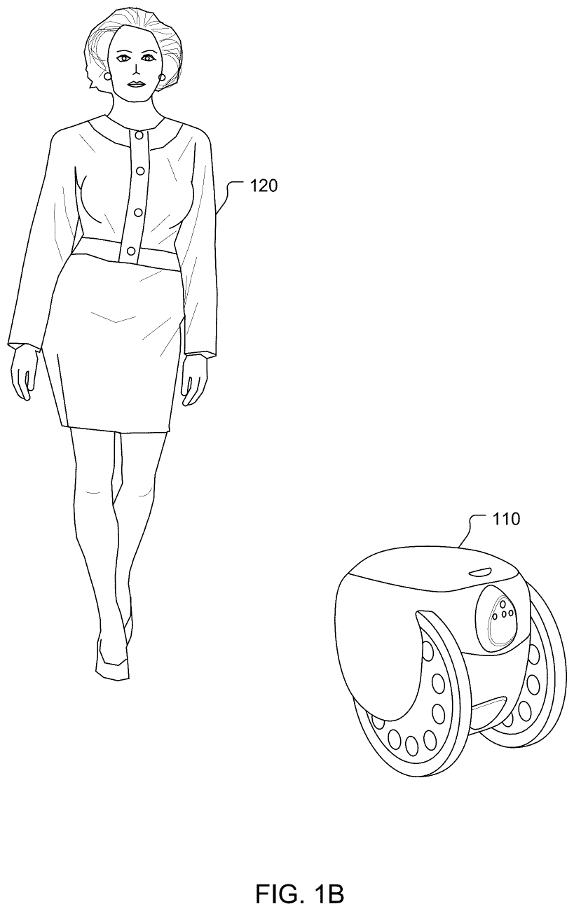

Referring to FIG. 1A, contactless pushing is illustrated between a robot 110 and a leader 120. As this is contactless pushing, the leader 120 is leading from behind to cause the robot 110 to move forward. The robot 110 senses the leader 120 and motion of the leader 120 and responds by moving forward in the same, or similar, direction as the leader 120 and at a speed relative to the leader 120 to maintain a separation distance between the robot 110 and the leader 120. Thus the robot's velocity (which is a vector) generally matches the velocity of the leader, subject to the circumstances described below in which the robot's velocity is subject to adjustment.

Referring also to FIG. 1B, contactless steering is illustrated between the robot 110 and the leader 120. As shown, the leader 120 is behind the robot 110 and has moved laterally relative to the robot 110 to push the robot 110 toward a desired direction. Lateral motion of the leader relative to the robot 110 indicates that the leader 120 wants the robot 110 to turn in a direction opposite to the lateral direction in which the leader 120 has moved relative to the robot 110. The motion of the leader 120 is thus a herding motion to push the robot 110 toward the desired direction of travel.

Various embodiments of the invention may share the following general features.
1. A robot is equipped with a set of sensors including at least one sensor, e.g., at least one optical sensor, coupled to a controller on the robot, allowing the robot to monitor motion of a leader with respect to the robot.
2. The controller is configured to control a motorized drive on the robot to respond to motion of the leader.
3. During contactless pushing, the leader's velocity and angular motion relative to the robot are, monitored by means of the set of sensors and, based on this velocity and angular motion, the controller causes the robot to move forward and navigate turns in a manner controllable by the leader.
4. During contactless pushing, if the leader moves in a direction at a velocity greater than a minimum triggering velocity, vₘᵢₙ, the robot will respond by moving in the direction so as to achieve and maintain a pre-programmed separation distance, the separation distance being determined by the velocity of the leader. Under this condition, as the leader's velocity increases above vₘᵢₙ, the robot's following distance will decrease, e.g., in a stepwise manner or in a continuous manner.
5. Based on the leader, engaged in contactless pushing, slowing down to a velocity less than vₘᵢₙ, a stopping behavior of the robot may be triggered. As the leader slows down, the robot's following distance will decrease, and the robot will slow down and, if the leader stops, the robot will stop.
6. During turning, the robot monitors the angular motion of the leader relative to the robot. Based on the leader's exceeding a threshold angular motion relative to the robot, the motorized drive will cause the robot to rotate, e.g., with a rotational angular acceleration that is greater than the leader's orbital angular acceleration.
7. During a final stage of a turn, based on the leader's angular motion, relative to the robot, falling below the threshold angular motion, the robot's angular motion decreases to zero, and the robot will be responsive to contactless pushing by the leader.

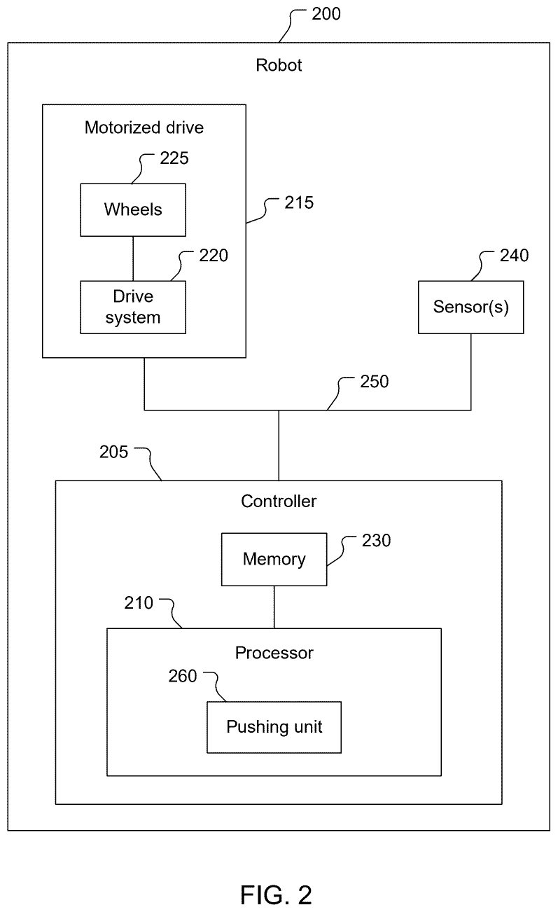

Referring also to FIG. 2, a robot 200 includes a controller 205 having memory 230 and a processor 210, a motorized drive 215 including a drive system 220 and wheels 225, and a set of sensors 240 communicatively coupled to each other by a bus 250. The robot 110 is an example of the robot 200. The motorized drive 215 includes wheels 225 that are used to move the vehicle in accordance with instruction provided by the controller 205. The controller 205 includes a set of processors, and the memory 230 may include one or more memories. The controller 205 may include one or more hardware devices, e.g., a central processing unit (CPU), a microcontroller, an application specific integrated circuit (A SIC), etc. The controller 205 may comprise multiple processors including a general-purpose/application processor, a Digital Signal Processor (DSP), a modem processor, a video processor, and/or a sensor processor. The memory 230 may be a non-transitory, processor-readable storage medium that may include random access memory (RAM), flash memory, disc memory, and/or read-only memory (ROM), etc. The memory 230 may store software which may be processor-readable, processor-executable software code containing instructions that are configured to, when executed, cause the controller 205 to perform various functions described herein. Alternatively, the software may not be directly executable by the controller 205 but may be configured to cause the controller 205, e.g., when compiled and executed, to perform the functions.

Reference in this description to the controller 205 as performing a function includes other implementations such as wherein the controller 205 executes instructions of software (stored in the memory 230) is implemented by firmware. The description herein may refer to the robot 200 performing a function as shorthand for one or more appropriate components (e.g., the controller 205 and the motorized drive 215) of the robot 200 performing the function. The controller 205 (possibly in conjunction with the motorized drive 215 and the set of sensors 240) may include a pushing unit 260. The pushing unit 260 may be configured to instruct the motorized drive 215 to move the robot 200 in accordance with contactless pushing by a leader as detected by the set of sensors 240. The pushing unit 260 may be configured to instruct the motorized drive 215 to turn the robot 200 in accordance with contactless steering by a leader. The pushing unit 260 is discussed further below, and the description may refer to the controller 205 generally, or the robot 200 generally, as performing any of the functions of the pushing unit 260, with the robot 200 being configured to perform the function(s). The pushing unit 260 may implement starting, basic pushing, steering (push-to-turn), and stopping behaviors of contactless pushing.

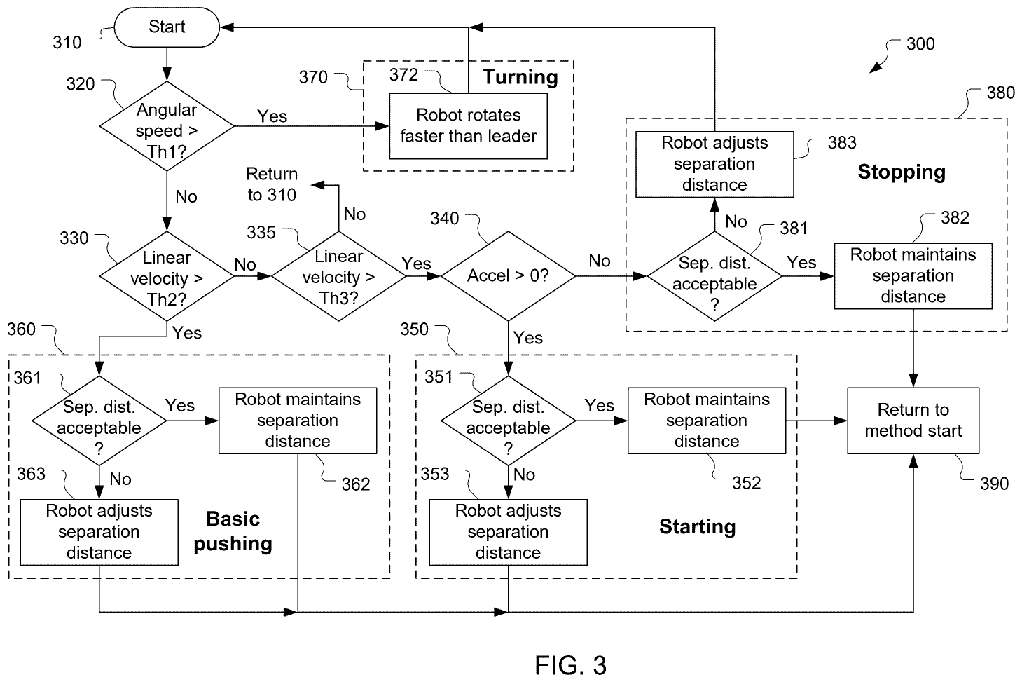

Referring also to FIG. 3, a method 300 of contactless pushing includes the stages shown. The method 300 is, however, an example and not limiting. The method 300 may be altered, e.g., by having one or more stages added, removed, rearranged, combined, performed concurrently, and/or having one or more stages split into multiple stages. The method 300 is a loop of monitoring for triggering contactless pushing operation and execution of appropriate contactless pushing operations, including starting 350, basic pushing 360, turning 370, and stopping 380.

At stage 310, the method 300 starts. The method 300 may begin at stage 310, e.g., at a point when the robot 200 is being turned on, or may continue at a point when the robot 200 is already being on and the method 300 returning to stage 310 from another stage as discussed below. The method 300 proceeds from stage 310 to stage 320.

At stage 320, the pushing unit 260 determines whether an angular speed of the leader 120 is greater than a threshold. For example, the pushing unit 260 may determine a direction of travel of the leader 120, with the direction of travel being relative to a reference (e.g., a global reference, or a local reference (e.g., an axis of the robot 200)). As discussed herein, the robot 200 may use the direction of travel of the leader 120 to affect a direction of travel of the robot 200. For example, the robot 200 may align with the direction of travel of the leader 120 (e.g., moving away from the leader 120 if the direction of travel is toward the robot 200, or turning and accelerating as appropriate to get in front of the leader 120 in the direction of travel, e.g., if the leader 120 moves away from the robot 200) or may turn based on the direction of travel of the leader 120 and eventually align with the direction of travel of the leader 120 (e.g., once the leader completes contactless steering of the robot 200 and settles on a travel direction). The pushing unit 260 may use the determined motion of the leader 120 to determine whether the angular speed of the leader 120 relative to the robot 200 is greater than a turning threshold angular speed, e.g., 13°/s, or between about 5° /s and about 20° /s. If the angular speed of the leader 120 is greater than the threshold, then turning (also called non-basic pushing, contactless steering, and/or push-to-turn) is triggered and the method 300 proceeds to stage 372 to execute a turn. If the angular speed of the leader 120 is not greater than the threshold, then the method 300 proceeds to stage 330.

At stage 330, the pushing unit 260 determines whether a linear velocity of the leader 120 is greater than a threshold. For example, the pushing unit 260 may determine whether the linear velocity of the leader 120 is greater than a basic-pushing threshold, e.g., 0.6 m/s. If the linear velocity of the leader 120 is greater than the threshold, then basic pushing is triggered and the method 300 proceeds to stage 361 for basic pushing. If the linear speed of the leader 120 is not greater than the threshold, then the method 300 proceeds to stage 335.

At stage 335, the pushing unit 260 determines whether a linear velocity of the leader 120 is greater than another threshold. For example, the pushing unit 260 may determine whether the linear velocity of the leader 120 is greater than a start-pushing threshold, e.g., 0.3 m/s. If the linear velocity of the leader 120 is not greater than the start-pushing threshold, then the method 300 returns to stage 310. If the linear velocity of the leader 120 is greater than the start-pushing threshold, then the method 300 proceeds to stage 340. The robot 200 may require a direction of the leader 120 to be toward the robot 200 for the method 300 to proceed to stage 340. Alternatively, the robot 200 may be configured to move (e.g., while in a contactless pushing mode) in front of the leader 120 even if the leader does not move toward the robot 200.

At stage 340, the pushing unit 260 determines whether the leader 120 is accelerating. If the pushing unit 260 determines that the leader 120 has acceleration greater than zero, then starting of contactless pushing is triggered and the method 300 proceeds to stage 351 to start contactless pushing. If the pushing unit 260 determines that the leader 120 has zero acceleration or negative acceleration, then stopping is triggered and the method 300 proceeds to stage 381 to implement stopping of the robot 200.

### Starting

At stage 351, based on starting being triggered, the pushing unit 260 determines whether there is an acceptable separation distance between the robot 200 and the leader 120. For example, the pushing unit 260 may determine whether the separation distance is at (or near) a desired starting separation distance such as 900 mm. As another example, the pushing unit 260 may determine whether the separation distance is within an acceptable starting separation distance range, e.g., between 880 mm and 910 mm. If the pushing unit 260 determines that the separation distance is acceptable, then the method 300 proceeds to stage 352 where the pushing unit 260 controls the motorized drive 215 to maintain acceptable separation distance. If the pushing unit 260 determines that the separation distance is unacceptable, then the method 300 proceeds to stage 353 where the pushing unit 260 controls the motorized drive 215 to adjust the separation distance to an acceptable separation distance. The pushing unit 260 may cause the motorized drive 215 increase the speed of the robot 200 to increase the separation distance (which is typically the case during start-up) or to decrease the speed of the robot 200 to decrease the separation distance. The method 300 proceeds from either stage 352 or stage 353 to stage 390 where the method 300 returns to stage 310.

A time period during which the leader 120 has a velocity within a range of v₁ to v₂ (i.e., between the start-pushing threshold and the basic-pushing threshold), where v₂>v₁, and an acceleration of greater than 0 is considered the “starting” period. Any velocity less than v₁ is considered to be static, and the robot 200 will have no linear motion. During the starting period, the robot 200 attempts to maintain a consistent separation distance of approximately d₁ (e.g., 900 mm or a range around 900 mm) between the leader 120 and the robot 200. The robot 200 may be configured such that, based on the separation distance being (e.g., falling) below Ad₁ or being (e.g., rising) above Bd₁ during this time (with A<1.0 and B>1.0), the robot 200 will accelerate (with an acceleration of no greater than Aₘₐₓ) or decelerate (with a deceleration of no less than Dₘᵢₙ) in order to return the separation distance d to a desired separation, e.g., within the desired range Ad₁<d<Bd₁. In an example embodiment, v₁ and v₂ are, respectively, about 0.3 m/s and about 0.6 m/s, d₁ is about 900 mm, Aₘₐₓ is about 0.75 m/s², and Dₘᵢₙ is about −0.62 m/s². One or more other values, however, may be used. For example, v₁ may be between about 0.1 m/s and about 0.5 m/s, s₂ may be between about 0.4 m/s and about 2 m/sec, d₁ may be between about 300 mm and about 2 m, Aₘₐₓ may be between about 0.5 m/s² and about 1.5 m/s², and Dₘᵢₙ may be between about −1.0 m/s² and about −0.3 m/s².

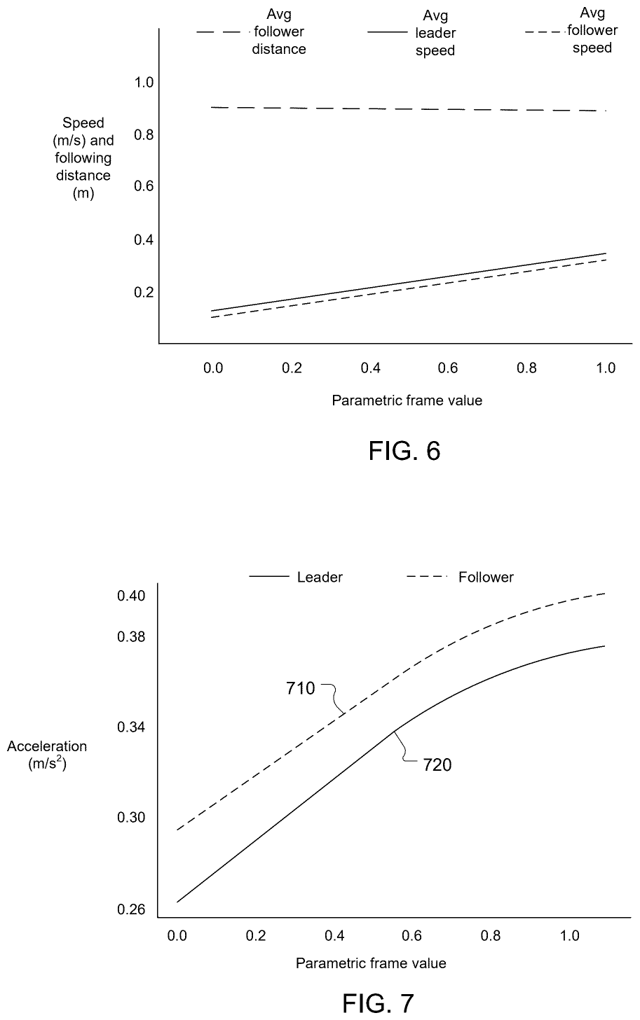

Experiments have shown that a separation distance between 800 mm and 1,000 mm is natural and comfortable for starting contactless pushing, and that acceleration of the leader 120 during starting of contactless pushing is typically below 0.4 m/s². For example, referring also to FIG. 6 and FIG. 7, experiments with person-to-person trials have shown an average separation distance of about 900 mm in the course of leader and follower speeds ranging from 0 m/s to 1.0 m/s, and a follower acceleration-over-time plot 710 having a similar shape as, but with greater acceleration than, a leader acceleration-over-time plot 720.

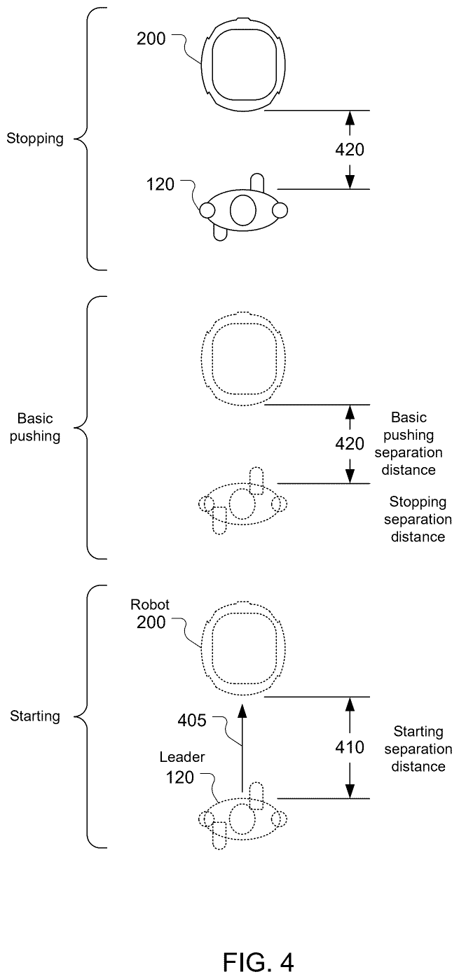

Referring also to FIG. 4, various stages of contactless pushing along a direction of travel 405 of both the robot 200 and the leader 120 are shown. In this example, the direction of travel 405 is a straight line. In a first, contactless pushing starting stage, the leader 120 moves toward the robot 200 at a velocity between v₁ and v₂, with a positive acceleration. This triggers the robot 200 to start contactless pushing by accelerating to establish an acceptable value for a separation distance 410 (e.g., by the time the leader 120 reaches the basic-pushing threshold velocity). The controller 205 may limit a velocity of the robot 200, e.g., to about 1.35 m/s.

### Basic Pushing

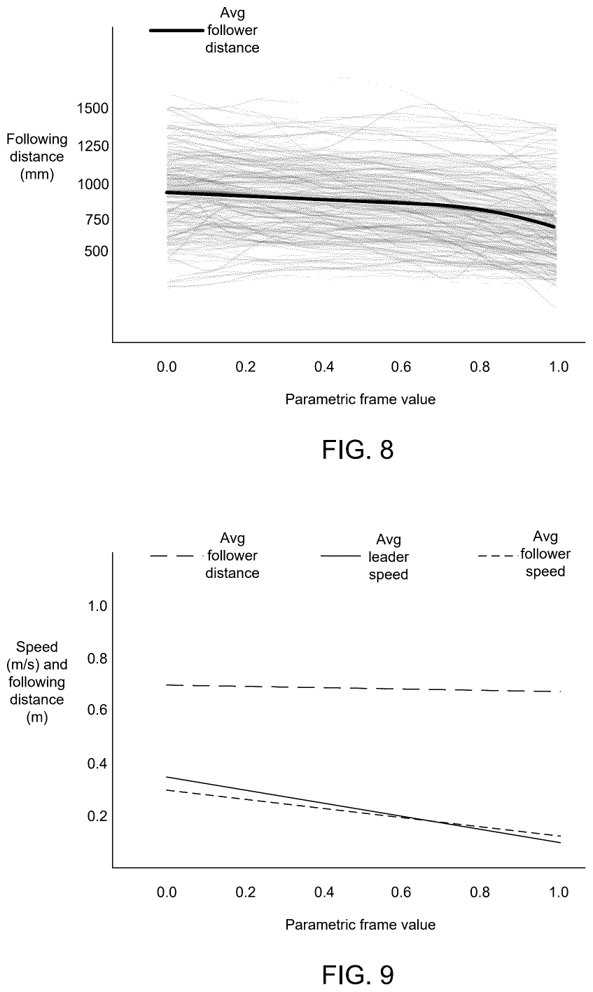

Referring again in particular to FIG. 3, at stage 361, based on basic pushing having been triggered, the pushing unit 260 determines whether there is an acceptable separation distance between the robot 200 and the leader 120. For example, the pushing unit 260 may determine whether the separation distance is at (or near) a desired basic-pushing separation distance such as 700 mm. As another example, the pushing unit 260 may determine whether the separation distance is within an acceptable basic-pushing separation distance range, e.g., between 680 mm and 720 mm. If the pushing unit 260 determines that the separation distance is acceptable, then the method 300 proceeds to stage 362 in which the pushing unit 260 controls the motorized drive 215 to maintain acceptable separation distance. If the pushing unit 260 determines that the separation distance is unacceptable, then the method 300 proceeds to stage 363 where the pushing unit 260 controls the motorized drive 215 to adjust the separation distance to an acceptable separation distance. The pushing unit 260 may cause the motorized drive 215 to decrease the speed of the robot 200 to decrease the separation distance or to increase the speed of the robot 200 to increase the separation distance. The pushing unit 260 may often decrease the separation distance during basic-pushing, especially following start-up where, in this example, the acceptable separation distance is greater than during basic pushing. The pushing unit 260 may cause the robot 200 to decrease velocity at a substantially constant rate, e.g., about 33 mm/s², until the separation distance is acceptable. Experiments have shown that the 33 mm/s² rate of separation distance decrease, to about 77% of the separation distance at the end of starting contactless pushing, is natural and comfortable for the leader 120. Referring also to FIG. 8, we have observed natural persons in the activity of person-to-person following, and have graphed following distances for activities including slight turns, 90° turns, sharp turns, and U-turns, with the average following distance decreasing from about 900 mm to about 700 mm. In programming operation of the robot, we have generally followed these observations. If the separation distance is outside of the basic-pushing separation distance range, then the pushing unit 260 may target a smaller acceptable range of separation distance, and once inside this smaller target range, revert to the larger basic-pushing separation distance range to provide hysteresis in the separation distance. The method 300 proceeds from either stage 362 or stage 363 to stage 390 where the method 300 returns to stage 310.

Referring again to FIG. 4, during basic pushing, the leader 120 has reached at least the basic-pushing threshold velocity v₂ and remains above v₂. During this period, the controller 205 may cause the robot 200 to decrease the separation distance between the robot 200 and the leader 120 from the separation distance 410 to a separation distance 420 (e.g., about 700 mm) that is less than the separation distance 410. The controller 205 may cause the separation distance to be reduced at a steady rate of r₁, e.g., slowly reducing the separation distance between the leader 120 and the robot 200 from a starting distance d₁ (or range including d₁) until the separation distance reaches a smaller acceptable separation distance of d₂ or a range including d₂. The separation distance may be maintained at an acceptable distance (or within a range of acceptable distances) during basic pushing (i.e., while in a basic-pushing mode or basic-pushing phase of contactless pushing), e.g., until a different behavior is triggered. The controller 205 may limit the robot 200 to a maximum (positive) acceleration of Aₘₐₓ and a maximum deceleration (i.e., a maximum negative acceleration) of no less than Dₘᵢₙ. The separation distance programming of the robot 200 for operation in the basic pushing phase as described here differs from typical behavior, for example, of a human driving a motor vehicle on a road in traffic. A human driver of a first motor vehicle typically increases the separation distance to a second motor vehicle as the velocity of the vehicles increases. It has been found, however, that in the basic-pushing phase, a different paradigm promotes improved human-robot interaction. Accordingly, after a second linear velocity threshold has been reached that exceeds a first linear velocity threshold, reduction of the separation distance between the robot 200 and the leader 120, below the separation distance applicable during the starting phase, is appropriate. In an example embodiment, v₂ is about 0.6 m/s, r₁ is about 33 mm/s, d₂ is about 700 mm, Aₘₐₓ is about 0.75 m/s² and Dₘᵢₙ is about −0.62 m/s². One or more other values, however, may be used. For example, s₂ may be between about 0.4 m/s and about 2 m/sec, r₁ may be between about 10 mm/s and about 100 mm/s, d₂ may be between about 200 mm and about 1.5 m, Aₘₐₓ may be between about 0.5 m/s² and about 1.5 m/s², and Dₘᵢₙ may be between about −1.0 m/s² and about −0.3 m/s².

### Stopping

Referring again in particular to FIG. 3, at stage 381, based on stopping having been triggered, the pushing unit 260 determines whether there is an acceptable separation distance between the robot 200 and the leader 120. For example, the pushing unit 260 may determine whether the separation distance is at (or near) a desired stopping separation distance such as 700 mm. As another example, the pushing unit 260 may determine whether the separation distance is within an acceptable stopping separation distance range, e.g., between 680 mm and 720 mm. If the pushing unit 260 determines that the separation distance is acceptable, then the method 300 proceeds to stage 382 where the pushing unit 260 controls the motorized drive 215 to maintain acceptable separation distance. If the pushing unit 260 determines that the separation distance is unacceptable, then the method 300 proceeds to stage 383 where the pushing unit 260 controls the motorized drive 215 to adjust the separation distance to an acceptable separation distance. The pushing unit 260 may cause the motorized drive 215 to decrease the velocity of the robot 200 to decrease the separation distance or to increase the velocity of the robot 200 to increase the separation distance. The pushing unit 260 may cause the robot 200 to increase or decrease velocity at a substantially constant rate, e.g., about 33 mm/s², until the separation distance is acceptable. If the separation distance is outside of the basic-pushing separation distance range, then the pushing unit 260 may target a smaller acceptable range of separation distance, and once inside this smaller target range, revert to the larger stopping separation distance range to provide hysteresis in the separation distance. The method 300 proceeds from either stage 382 or stage 383 to stage 390 where the method 300 returns to stage 310.

Referring again to FIG. 4, during a stopping phase, the velocity of the leader 120 has decreased to between the basic-pushing threshold velocity (v₁) and the starting-pushing threshold speed (v₂) with a negative acceleration. During this period, the controller 205 may cause the robot 200 to maintain the separation distance of d₂ while decreasing speed. The controller 205 may cause the separation distance to be varied at a steady rate of r₁, e.g., slowly reducing or increasing the separation distance between the leader 120 and the robot 200 as appropriate. The separation distance may be maintained at an acceptable distance (or within a range of acceptable distances) during stopping, e.g., until a different behavior is triggered or based on a velocity of the leader 120 rising above a threshold, e.g., −0.4 m/s. The controller 205 may limit the robot 200 to a maximum (positive) acceleration of Aₘₐₓ and a maximum deceleration (i.e., a maximum negative acceleration) of no less than Dₘᵢₙ. In an example embodiment, v₁ and v₂ are, respectively, about 0.3 m/s and about 0.6 m/s, d₂ is about 700 mm, Aₘₐₓ is about 0.75 m/s², and Dₘᵢₙ is about −0.62 m/s². One or more other values, however, may be used. For example, v₁ may be between about 0.1 m/s and about 0.5 m/s, v₂ may be between about 0.4 m/s and about 2 m/sec, d₂ may be between about 300 mm and about 2 m, Aₘₐₓ may be between about 0.5 m/s² and about 1.5 m/s², and Dₘᵢₙ may be between about −1.0 m/s² and about −0.3 m/s². Experiments have shown that a separation distance during stopping of between 630 mm and 995 mm (with an average of about 700 mm) is natural and comfortable for the leader 120. For example, referring also to FIG. 9, experiments with person-to-person trials showed an average separation distance of about 700 mm over leader and follower speeds from about 0.38 m/s to less than 0.2 m/s. In programming of the robot, we have implemented these observations for operation of the robot.

### Turning

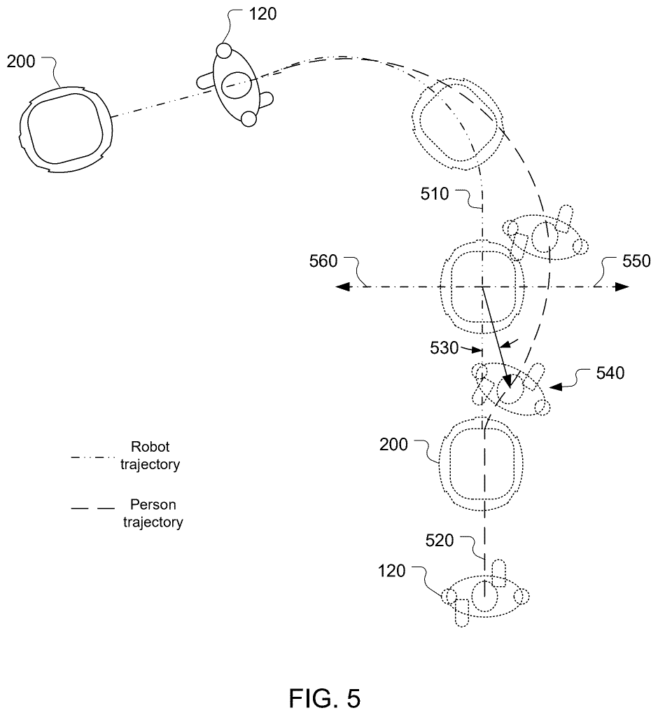

Referring again in particular to FIG. 3, and with further reference to FIG. 2 and FIG. 5, at stage 372, based on turning having been triggered, the pushing unit 260 initiates a turn by the robot 200. As shown in the example of FIG. 5, the robot 200 turns along a trajectory 510 in response to a trajectory 520 of the leader 120. The direction of travel of each of the robot 200 and the leader 120 changes over time for a turn.

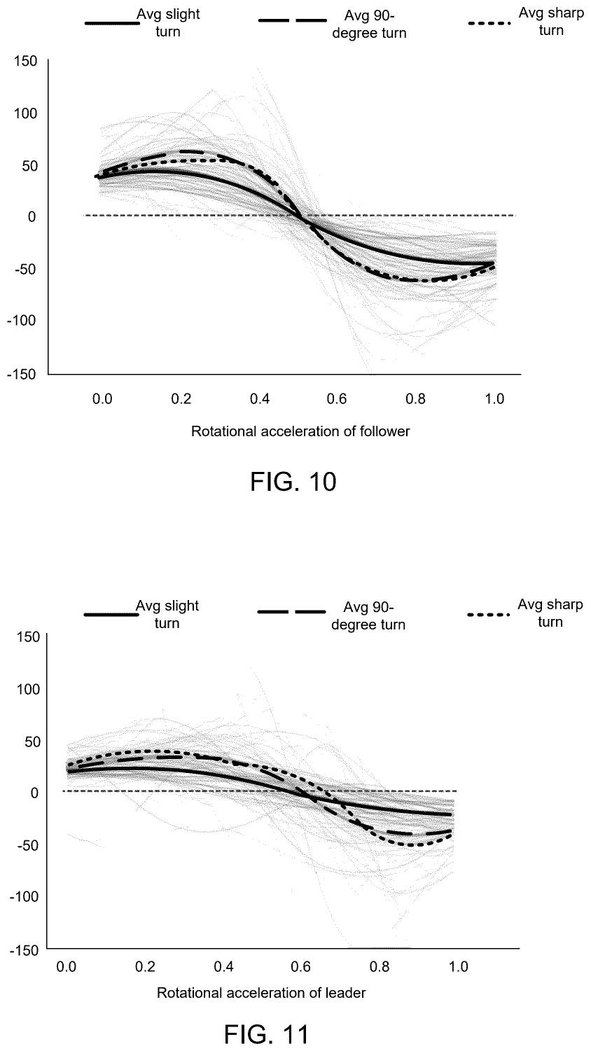

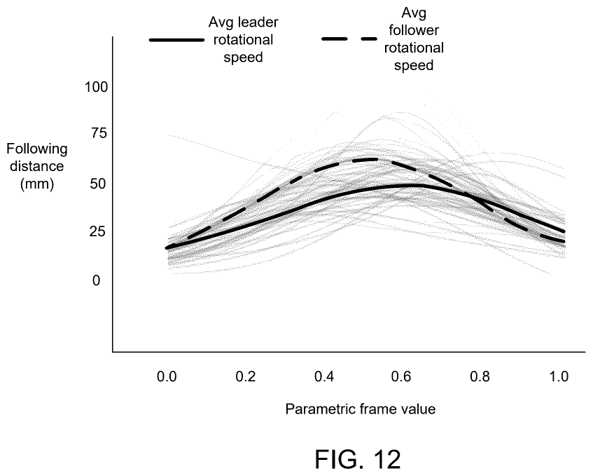

Having determined at stage 320 that an angular speed of the leader 120 relative to the robot 200 (e.g., a change in an angle 530 per second) exceeds the turning threshold, a turning period begins and the pushing unit 260 may determine that a direction of the leader 120 is at least partially in a lateral direction relative to the robot 200. In the example shown in FIG. 5, the pushing unit 260 may determine that the motion of the leader 120 at position 540 is at least partially in a starboard direction 550 relative to the robot 200. Consequently, the pushing unit 260 may initiate a turn toward an opposite lateral direction, in this case a port direction 560. The pushing unit 260 may cause the drive system 220 to rotate the wheels 225 such that the robot 200 turns (at least initially) with a robot rotational acceleration α_{R} that is greater than a leader angular acceleration al of the leader 120 relative to the robot 200, e.g., while attempting to maintain the separation distance constant between the leader 120 and the robot 200. For example, the robot rotational acceleration α_{R} may be about 1.75 times greater than the leader angular acceleration al of the leader 120. Other robot rotational accelerations may, however, be used, e.g., between about 1.25 and about 2.25 times greater than the leader angular acceleration. Referring also to FIG. 10 and FIG. 11, experimental rotational acceleration is shown for a follower (FIG. 10) and a leader (FIG. 11) based on person-to-person trials for various turn angles (e.g., slight turns (much less than 90°), 90° turns, and sharp turns (much greater than 90°)). The pushing unit 260 may limit the robot rotational acceleration to a maximum rotational acceleration, e.g., about 55°/s². The greater robot rotational acceleration may compensate for a delay in beginning a turn to determine the lateral motion of the leader 120 relative to the robot 200. Experiments have shown that a natural turn by the robot 200 in response to contactless steering by the leader 120 results in the rotational speed of the robot 200 during the turn peaking before (earlier in time) than the rotational speed of the leader 120 peaks, likely due to the overcorrection. For example, referring also to FIG. 12, rotational speed of multiple 90° turns was observed in person-to-person trials, with the average rotational speed of the robot peaking before the average rotational speed of the leader. Overcorrection or oversteering of the robot 200 may be compensated/corrected during the turn and/or during basic pushing of the robot 200 to have the robot 200 travel in the same direction as the leader 120 after a turn.

The pushing unit 260 may slow the robot rotational speed, e.g., proportional to slowing of the leader angular speed relative to the robot 200, and terminate the turn (putting the rotational speed of the robot 200 to zero (0)), e.g., based on the leader angular speed relative to the robot falling below a turn-stopping threshold, e.g., 13°/s. In this example, the turning threshold and the turn-stopping threshold are the same, but this is not required and these thresholds may be different. With the turn complete, the leader 120 may continue leading the robot 200 forward from behind, e.g., in a straight line or into another turn (e.g., in the same direction, or in a different direction (e.g., to produce a chicane turn (i.e., a turn toward one direction, e.g., toward port as shown, followed (quickly, e.g., immediately) by a turn in the opposite direction, e.g., toward starboard)). The method 300 returns from stage 372 to stage 310 for further pushing activity, e.g., basic pushing, further turning, or stopping. Experiments have shown that an angular speed of the leader 120 relative to the robot 200 increasing to at least about 13°/s, regardless of direction of the leader 120, is an indication of a turn being desired/indicated by the leader 120. Experiments have shown that an angular speed of the leader 120 relative to the robot 200 decreasing below about 21°/s, is an indication of a turn being stopped by the leader 120.

### Other Considerations

The discussion herein provides example rules to control robot behavior during motion in a straight line (basic contactless pushing), during the navigation of a single turn (contactless steering), and during more complex navigation, e.g., of a series of turns (chicane turns).

In a further related embodiment, the robot can be programmed to address a circumstance in which, for example, the robot is being navigated over a sidewalk that includes a modest curve in a given direction. In this circumstance it may be inconvenient for the leader to signal a turn by a herding-like gesture in the opposite direction. Accordingly, the robot can be programmed to observe (in the forward direction) the impending curve in the sidewalk, and, in the absence of contrary instruction by gesture from the leader, to follow the curve. Additionally the robot can be programmed in this circumstance to confirm that the leader's trajectory is tracking the curve of the sidewalk, and otherwise, the robot can, as usual, follow the leader's trajectory.

Other examples and implementations are within the scope of the disclosure and appended claims. For example, due to the nature of software and computers, functions described above can be implemented using software executed by a controller, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system. Further, the threshold numerical values provided for distances, linear motion, and rotational motion are examples, and different values for these items may be used, e.g., for different applications.

What is claimed is:

1. A robot capable of autonomous motion responsive to contactless pushing by a leader, the robot being a self-powered vehicle comprising:
a motorized drive;
a controller coupled to the motorized drive; and
a set of sensors coupled to the controller, so as to support autonomous motion of the vehicle;
wherein the controller is configured to:
sense, based on a set of signals from the set of sensors, movement of the leader in a leader trajectory; and
operate the motorized drive so as to move the vehicle, based on the leader trajectory, in a manner wherein the vehicle is positioned substantially in front of the leader.

2. The robot of claim 1, wherein the controller is further configured to operate the motorized drive in a manner so as to achieve and maintain a separation distance of the vehicle in front of the leader.

3. The robot of claim 2, wherein the controller is further configured to operate the motorized drive so as to maintain the separation distance as a function of a linear velocity of the leader in a direction toward the vehicle.

4. The robot of claim 3, wherein the controller is further configured to operate the motorized drive to maintain the separation distance in a set of tiers as a function of the linear velocity of the leader in a direction toward the vehicle, wherein the separation distance is maintained at distance d₁ when the linear velocity of the leader in a direction toward the vehicle exceeds a first threshold linear velocity v₁ above zero.

5. The robot of claim 4, wherein the controller is further configured to operate the motorized drive to maintain the separation distance in a set of tiers as a function of the linear velocity of the leader in a direction toward the vehicle, wherein the separation distance is maintained at distance d₁ when the linear velocity of the leader in a direction toward the vehicle exceeds a first threshold linear velocity v₁ above zero and at a distance d₂, d₂<d₁, when the linear velocity of the leader in a direction toward the vehicle exceeds a second threshold velocity v₂, v₂>v₁.

6. The robot of claim 5, wherein v₁ is about 0.2 m/s, v₂ is about 0.6 m/s, d₁ is about 900 mm, and d₂ is about 700 mm.

7. The robot of claim 5, wherein, under a condition in which the linear velocity of the leader in a direction toward the vehicle has just exceeded the second threshold velocity v₂, the controller is further configured to operate the motorized drive to decrease the separation distance from d₁ to d₂ at a rate between about 10 and 100 mm/s.

8. The robot of claim 5, wherein the controller is further configured to operate the motorized drive to stop movement of the vehicle under a condition in which the linear velocity of the leader in a direction toward the vehicle has just fallen below v₁.

9. The robot of claim 1, wherein:
the controller is further configured to determine presence of a rotational condition in which (i) the leader trajectory includes a component that is transverse to a line segment between the leader and the vehicle, so that there is angular motion of the leader, relative to the vehicle, and (ii) the angular motion of the leader is at an angular speed exceeding a threshold; and
under the rotational condition, the controller is further configured to operate the motorized drive to rotate the vehicle about a rotational axis so as to be aimed in a direction defined by the line segment.

10. The robot of claim 9, wherein the controller is further configured to operate the motorized drive to rotate the vehicle about the rotational axis with a rotational speed based on the angular speed of the leader.

11. The robot of claim 9, wherein under the rotational condition the controller is further configured to determine angular acceleration of the leader and to operate the motorized drive to rotate the robot about the rotational axis with an angular acceleration based on the determined angular acceleration of the leader.

12. The robot of claim 11, wherein the controller is further configured to operate the motorized drive to rotate the robot about the rotational axis with an angular acceleration that is at least 1.5 times the determined angular acceleration of the leader.

13. A method of operating a robot that is a self-powered vehicle equipped with a motorized drive, a controller coupled to the motorized drive, and a set of sensors coupled to the controller, so as to support autonomous motion of the vehicle, in a manner responsive to contactless pushing by a leader, the method comprising:
sensing, based on a set of signals from the set of sensors, movement of the leader in a leader trajectory; and
operating the motorized drive so as to move the vehicle, based on the leader trajectory, in a manner wherein the vehicle is positioned substantially in front of the leader.

14. The method of claim 13, further comprising:
determining by the processor, based on data from the set of sensors, a linear velocity of the leader in a direction towards the robot; and
causing, by the processor, operation of the drive system to move the robot in the direction in a manner to achieve and maintain a separation distance from the leader, the separation distance being determined as a function of the linear velocity of the leader towards the robot.

15. The method of claim 14, further comprising:
operating the motorized drive to maintain the separation distance in a set of tiers as a function of the linear velocity of the leader in a direction toward the vehicle, wherein the separation distance is maintained at distance d₁ when the linear velocity of the leader in a direction toward the vehicle exceeds a first threshold linear velocity v₁ above zero.

16. The method of claim 15, further comprising:
operating the motorized drive to maintain the separation distance in a set of tiers as a function of the linear velocity of the leader in a direction toward the vehicle, wherein the separation distance is maintained at distance d₁ when the linear velocity of the leader in a direction toward the vehicle exceeds a first threshold linear velocity v₁ above zero and at a distance d₂, d₂<d₁, when the linear velocity of the leader in a direction toward the vehicle exceeds a second threshold velocity v₂, v₂>v₁.

17. The method of claim 16, wherein v₁ is about 0.2 m/s, v₂ is about 0.6 m/s, d₁ is about 900 mm, and d₂ is about 700 mm.

18. The method of claim 16, wherein, under a condition in which the linear velocity of the leader in a direction toward the vehicle has just exceeded the second threshold velocity v₂, operating the motorized drive to decrease the separation distance from d₁ to d₂ at a rate between about 10 and 100 mm/s.

19. The method of claim 18 further comprising operating the motorized drive to stop movement of the vehicle under a condition in which the linear velocity of the leader in a direction toward the vehicle has just fallen below v₁.

20. The method of claim 13, further comprising:
determining presence of a rotational condition in which (i) the leader trajectory includes a component that is transverse to a line segment between the leader and the vehicle, so that there is angular motion of the leader, relative to the vehicle, and (ii) the angular motion of the leader is at an angular speed exceeding a threshold; and
under the rotational condition, operating the motorized drive to rotate the vehicle about a rotational axis so as to be aimed in a direction defined by the line segment.

21. The method of claim 20, further comprising operating the motorized drive to rotate the vehicle about the rotational axis with a rotational speed based on the angular speed of the leader.

22. The method of claim 21, further comprising determining angular acceleration of the leader and to operate the motorized drive to rotate the robot about the rotational axis with an angular acceleration based on the determined angular acceleration of the leader.

23. The method of claim 22, further comprising operating the motorized drive to rotate the robot about the rotational axis with an angular acceleration that is at least 1.5 times the determined angular acceleration of the leader.
